(19) United States
(12) Patent Application Publication
(10) Pub. No.: US 2016/0344671 A1
(43) Pub. Date: Nov. 24, 2016

(54) EXECUTING COMMANDS ON VIRTUAL MACHINE INSTANCES IN A DISTRIBUTED COMPUTING ENVIRONMENT

(71) Applicant: Amazon Technologies, Inc., Seattle, WA (US)

(72) Inventors: Amjad Hussain, Bellevue, WA (US); Steven Merlin Twitchell, Renton, WA (US); Mats Erik Lanner, Seattle, WA (US); Manivannan Sundaram, Bothell, WA (US); Sivaprasad Venkata Padisetty, Bellevue, WA (US); Martin Chen Mao, Seattle, WA (US)

(21) Appl. No.: 14/716,713

(22) Filed: May 19, 2015

(51) Int. Cl. H04L 12/58; H04L 29/08

(52) U.S. Cl. CPC H04L 51/18; H04L 51/046; H04L 67/10

(57) ABSTRACT

A method for executing commands on virtual machine instances in a distributed computing environment can include receiving, from a client computing device, a command execution request for executing a command on one or more virtual machine instances within the distributed computing environment. The command execution request includes a tag, and instance identification information for the one or more virtual machine instances is retrieved based on the tag. A command specification document associated with the command specified by the command execution request is retrieved. A command execution message, including the command specification document and at least one command parameter, is communicated to each of the one or more virtual machine instances. A command execution result from executing the command at the one or more virtual machine instances is received from the one or more virtual machine instances. The command execution result is sent to the client computing device.

### BACKGROUND

Cloud computing is the use of computing resources (hardware and software) that are available in a remote location and accessible over a network, such as the Internet. In a computing environment with many computing devices, such as a virtual server or cloud computing environment with many server computers, the use of computing resources can provide a number of advantages including cost advantages and/or the ability to adapt rapidly to changing computing resource needs.

To facilitate increased utilization of data center resources, virtualization technologies may allow a single physical computing machine to host one or more virtual machine instances that appear and operate as independent instances to a connected computer user. With virtualization, the single physical computing device can create, maintain or delete virtual machine instances in a dynamic manner. In turn, users can request computer resources from a data center and be provided with varying numbers of virtual machine resources on an “as needed” basis or at least on an “as requested” basis. Various configuration, trouble-shooting and resource re-allocation issues may arise for a customer of the cloud computing environment managing a plurality (e.g., a fleet) of instances running applications or managing other workloads. With the increased use of cloud computing resources, administering, managing and trouble-shooting virtual machine instances may be performed on an instance-by-instance basis, which may be time consuming and inefficient.

### BRIEF DESCRIPTION OF DRAWINGS

Various embodiments in accordance with the present disclosure will be described with reference to the drawings, in which:

FIG. 1 is a diagram of an example network environment supporting a command execution service, in accordance with an embodiment of the disclosure.

FIG. 2 is a block diagram of an example communication sequence for executing a command on an instance, in accordance with an embodiment of the disclosure.

FIG. 3 is a block diagram illustrating command extensibility in a service provider environment using a command execution service, in accordance with an embodiment of the disclosure.

FIG. 4 is an example system diagram showing a plurality of virtual machine instances running in a multi-tenant environment, using a command execution service, in accordance with an example embodiment of the disclosure.

FIG. 5 shows further details of an example system including a plurality of management components associated with a control plane, which may be used to provide command execution services according to one embodiment.

FIG. 6 shows an example of a plurality of host computers, routers, and switches—which are hardware assets used for running virtual machine instances—with the host computers having command execution-related functionalities that may be configured according to one embodiment.

FIGS. 7-8 are flowcharts of example methods of executing commands on virtual machine instances in a service provider environment, in accordance with an embodiment of the disclosure.

FIG. 9 depicts a generalized example of a suitable computing environment in which the described innovations may be implemented.

### DETAILED DESCRIPTION

The following description is directed to techniques and solutions supporting execution of commands on virtual machine instances in a distributed computing environment. More specifically, a user of the distributed computing environment may use a client computing device to send a command execution request to the distributed computing. A command execution service (CES) may receive the request and may retrieve one or more instance IDs based on the request (e.g., based on instance IDs or a tag identified in the request). The request may further identify the desired command and one or more parameters of the command. The CES can retrieve a command specification/definition document that defines the command. A command execution message may be generated for each of the identified instances, where each message may include the command specification document and the parameters identified by the received request. The CES may use an instance messaging service (or another type of communication service) to send each command execution message to the corresponding virtual machine instance. A configuration agent at the instance may retrieve a plugin based on the command specification document, and the plugin can be used to execute the command on the instance. A result of the command execution can be returned back to the CES and then to the client computing device. The command specification documents can be maintained/managed via the CES, allowing for the use of global command specifications (global commands for use by all clients of the distributed computing) as well as custom commands. For example, a command specification and a corresponding command plugin are generated by a client and uploaded to the CES and/or a server computer running the client instance (e.g., the specification can be uploaded to the CES and the plugin can be uploaded/stored at the server computer running the client's instances for use by the instance configuration agents). In this regard, the CES is integrated into the distributed computing environment, allowing for command extensibility (e.g., increasing number of available commands) and bulk communication of commands for execution on instances in a secure manner.

A virtual machine image contains an operating system (e.g., Linux) and other data needed to launch a virtual machine in a virtual environment. The virtual machine image is similar to a physical computer's disk volume, and may include a file system, the operating system and other components needed to boot up as a machine. In order to launch a virtual machine, hardware needs to be selected. The hardware selection may be accomplished through instance types, which may allow a variety of different sizes of memory, CPU capacity, I/O performance, and so forth. The combination of the virtual machine image and the instance type can be used to create an “instance” or a virtual machine, which may be launched on a cloud computing resource, such as a host server computer in a multi-tenant network environment. As used herein, the terms “virtual machine” and “virtual machine instance” are interchangeable.

As used herein, the term “compute service provider” can refer to a cloud provider capable of delivering computing and storage capacity as a service to one or more end recipients. The compute service provider can be established for an organization (i.e., a tenant) by, or on behalf of, the organization (that is, the compute service provider may offer a “private cloud environment”). In other instances, the compute service provider can support a multi-tenant environment, where a plurality of customers (i.e., tenants) operate independently (i.e., a public cloud environment). In this regard, the plurality of customers (e.g., multiple enterprises or tenants) can rent resources, such as server computers, within the multi-tenant environment.

As used herein, the term “service provider” (or “service provider environment”) may refer to a provider delivering one or more of distributed computing services associated with a private or public cloud environment to one or more end recipients. In some instances, the service provider may be the same as a cloud service provider. In other instances, the service provider may only provide a subset of the services provided by a compute service provider. In yet other instances the service provider is an on-premise service provider for on-premise computing services.

As used herein, the term “tag” may refer to a character (e.g., text) string identifying one or more network resources (e.g., virtual machine instances) that have a commonality (e.g., virtual machine instances associated with an account of customer of a service provider environment). For example, a plurality of virtual machine instances of a given customer can be tagged or labeled (e.g., by the customer or an administrator of the service provider environment.) In this regard, a single tag may be used to identify a plurality of customer instances, and the identification information for the instances (e.g., instance IDs) can be retrieved by the tag (e.g., from a look-up table, a database, and so forth).

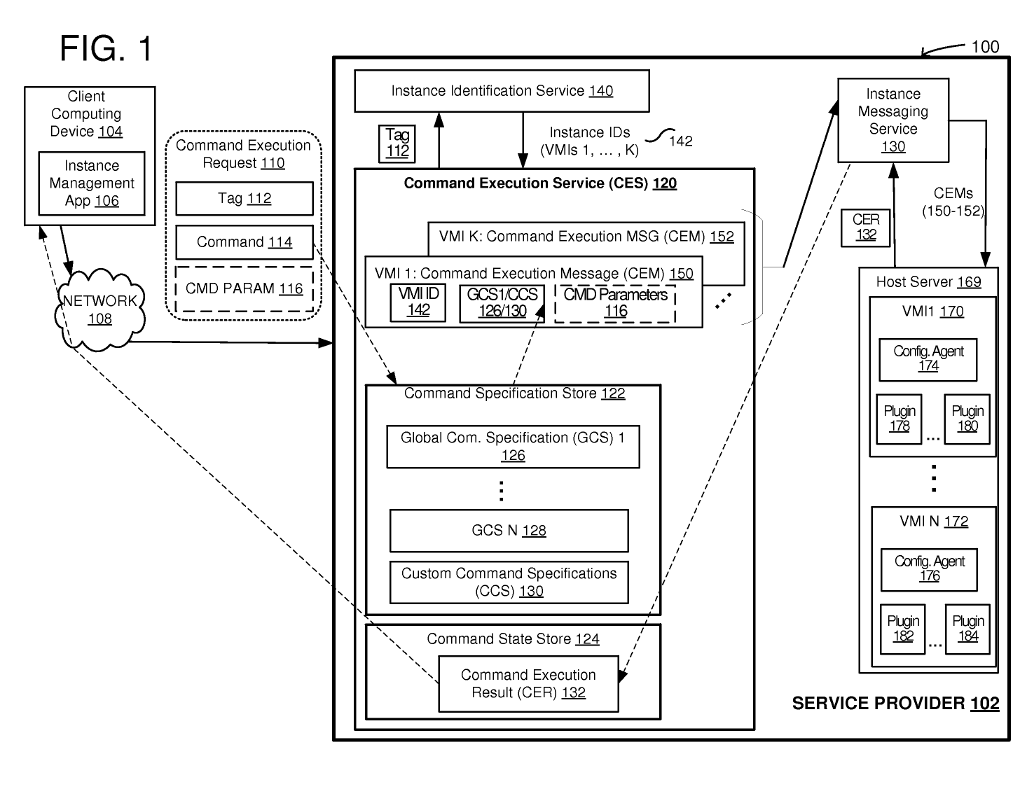

FIG. 1 is a diagram of an example network environment supporting a command execution service, in accordance with an embodiment of the disclosure. Referring to FIG. 1, the network environment 100 may include a service provider 102 in communication with a client computing device 104 via the network 108. The service provider 102 may be a multi-tenant cloud network environment where one or more clients (e.g., a user of the client computing device 104) may run one or more virtual machine instances (VMIs) on one or more of server computers (e.g., instances 170, . . . , 172 can run on one or more server computers such as host server 169 or the instances may run on other physical hardware) (even though only a single server computer 169 is illustrated in FIG. 1, multiple server computers can be used by the service provider 102). The server computers (e.g., 169) may be, for example, client servers operated by (or on behalf of) one or more clients of the service provider 102. The service provider 102 may further comprise an instance identification service 140, an instance messaging service 130, and a command execution service (CES) 120.

The client computing device 104 may be used for providing access to one or more of the virtual machine instances 170, . . . , 172 to a user of the device 104. In an illustrative embodiment, the client computing device 104 can correspond to a wide variety of computing devices including personal computing devices, laptop computing devices, hand-held computing devices, terminal computing devices, mobile devices (e.g., mobile phones, tablet computing devices, electronic book readers, etc.), wireless devices, various electronic devices and appliances, and the like. In an illustrative embodiment, the client computing device 104 includes necessary hardware and software components for establishing communications over a communication network 108, which may include the Internet, a wide area network and/or a local area network. For example, the client computing device 104 may be equipped with networking equipment and browser software applications that facilitate communications via the Internet or an intranet with one or more of the server computers (e.g., 169) in the service provider 102. The client computing device 104 may have varied local computing resources such as central processing units and architectures, memory, mass storage, graphics processing units (GPUs), communication network availability and bandwidth, etc.

In one embodiment, the client computing device 104 may run an instance management application 106. The instance management application 106 may be used to access and manage one or more of the VMIs 170, . . . , 172. Additionally, the instance management application 106 can include a command line interface (CLI) and/or a console user interface, which may be used to communicate one or more commands to the service provider 102 for execution on at least one of the VMIs 170, . . . , 172.

The command execution service (CES) 120 may comprise suitable logic, circuitry, interfaces, and/or code and may be operable to provide functionalities associated with executing commands on one or more of the VMIs 170, . . . , 172. The CES 120 may also include a command specification store 122 and a command state store 124. The command specification store 122 may be used to store one or more command specification documents, such as global command specifications (GCS) 126, . . . , 128 and one or more custom command specifications (CCS) 130. The term “command specification” (or “command definition”) as used herein refers to a document providing a definition of a command for execution on an instance. In an example embodiment, the command specification is a JavaScript Object Notation (JSON) document with human-readable text used for transmitting data objects consisting of attribute-value pairs. The global command specifications 126, . . . , 128 may be used by any client of the service provider environment 102. The custom command specifications 130 include command specifications provided by a client of the service provider environment (e.g., user of the client device 104).

The command state store 124 may be used to store one or more command execution results (e.g., 132) from executing a command on a VMI. The command execution result 132 may include a state of execution for a given command and/or a result/output from executing a command on a VMI. Even though the stores 122 and 124 are illustrated as separate stores, the invention is not limited in this regard and a single store may be used as a combination of stores 122 and 124.

The instance identification service 140 may comprise suitable circuitry, interfaces, logic and/or code and may be used to provide instance IDs for VMIs running in the service provider environment 102. For example, the instance identification service 140 can use a look-up table or a database, and may provide VMI IDs based on a tag (e.g., one or more VMIs of the available VMIs 170, . . . , 172 can be associated with a tag).

The instance messaging service 130 may comprise suitable circuitry, interfaces, logic and/or code and may be operable to communicate messages (e.g., a command) and responses (e.g., command execution result) between the CES 120 and one or more of the VMIs 170, . . . , 172.

The virtual machine instances 170, . . . , 172 may also include corresponding configuration agents 174, . . . , 176. Each configuration agent 174, . . . , 176 may comprise suitable logic, interfaces, and/or code and may be operable to manage execution and running of the VMI, including receiving a command (e.g., a command execution message 150, . . . , 152) and selecting one of a plurality of available plugins (e.g., 178, . . . , 184) for executing the command. In an example embodiment, the configuration agents 174, . . . , 176 may run as applications on the corresponding instances 170, . . . , 172.

In accordance with an example embodiment of the disclosure, the command execution service 120 may be implemented as a stand-alone service within the service provider 102 (as illustrated in FIG. 1) or it may be implemented as a code library (i.e., software) within one or more of the server computers (e.g., 169).

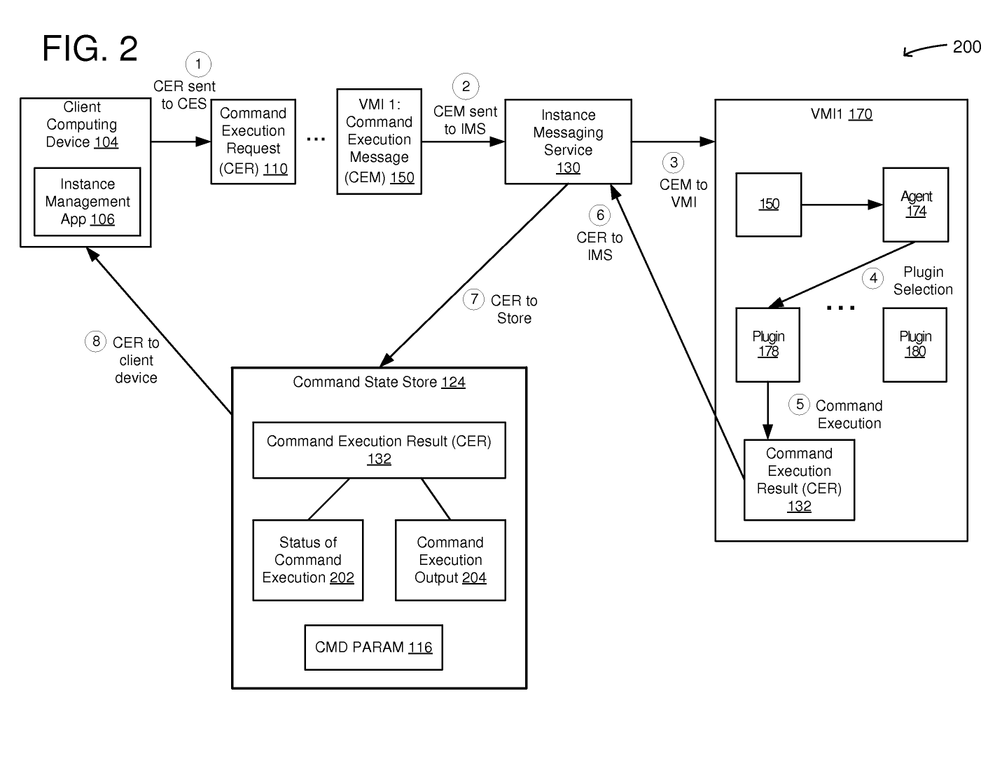

FIG. 2 is a block diagram of an example communication sequence for executing a command on an instance, in accordance with an embodiment of the disclosure. Referring to FIGS. 1-2 and in an example operation, a user/client of the service provider 102 may use the application 106 on device 104 to send (at index la) a command execution request (CER) 110 to the CES 120. The CER 110 may identify a command the user wants to execute on one or more of the instances 170, . . . , 172. The CER 110 may also include a tag 112 (and/or one or more VMI IDs such as 142) and optionally, command parameters 116 (the tag 112 can include more than one tags and/or one or more VMI identifiers such as VMI IDs). After the CES 120 receives the command execution request 110, the CES 120 may initially authenticate the requesting user and verify the user's login credentials allow access to the VMIs associated with the tag. The CES 120 may then communicate the tag 112 to the instance identification service 140, and obtain the instance IDs 142 of the VMIs 170, . . . , 172 associated with the tag 112. The CES 120 may then retrieve a command specification document (e.g., 126 or 130) from the store 122, where the retrieved command specification is associated with the command 114 identified by the CER 110. The CES 120 may then generate a command execution message (CEM) for each of the VMIs (e.g., VMI 1, . . . , VMI K) identified by the tag 112 and the instance IDs 142. Each of the CEMs 150, . . . , 152 can include the instance ID 142, the retrieved specification document (e.g., global document 126 or a custom specification document 130) and the command parameters 116 received with the CER 110. The parameters 116 can be used with the specification document (e.g., by a plugin) to execute the identified command. The command 114 may be pre-defined (e.g., may be selected from a plurality of available commands).

In an example embodiment, the specification documents 126 and/or 130 may be included in the CEMs 150, . . . , 152 based on the specification document size. For example, if the specification document is smaller than a pre-determined size (e.g., a threshold value), the document 126/130 can be included in the CEMs 150, . . . , 152. However, if the specification document is larger than the pre-determined size, then an identification of the document (e.g., a link to the document) can be included in the CEMs. Upon receipt of the CEMs, the corresponding VMI configuration agent may use the document identification (e.g., link) and extract/retrieve the full specification document so that the command associated with the document can be executed.

The generated CEMs 150, . . . , 152 may then be communicated to each respective VMI identified by the CEMs via the instance messaging service 130 (at index 2 and 3 in FIG. 2). For example, the CEM 150 may be communicated to the VMI 170. The configuration agent 174 can use the command specification document within the command execution message 150 to select a plugin (e.g., 178) from available plugins 178, . . . , 180 (at index 4). The VMI configuration agent 174 may then use the plug-in 178 to execute the command 114 (at index 5) using the specification document 126 and the command parameters 116. A command execution result 132 may be generated during (or after) the execution of the command, and may be communicated to the CES 120 via the instance messaging service 130 (at index 6). The CES 120 may store the result 132 in the command state store 124 (at index 7) and communicate it to the client device 104 (at index 8). The results 132 may be a command execution state and/or an output generated after the command has been executed. In an example implementation, the command execution results 132 from each of the VMIs 1, . . . , K can be aggregated and sent to the device 104 after aggregation. If the CER includes command parameters 116, the parameters 116 can be stored in the command state store 124.

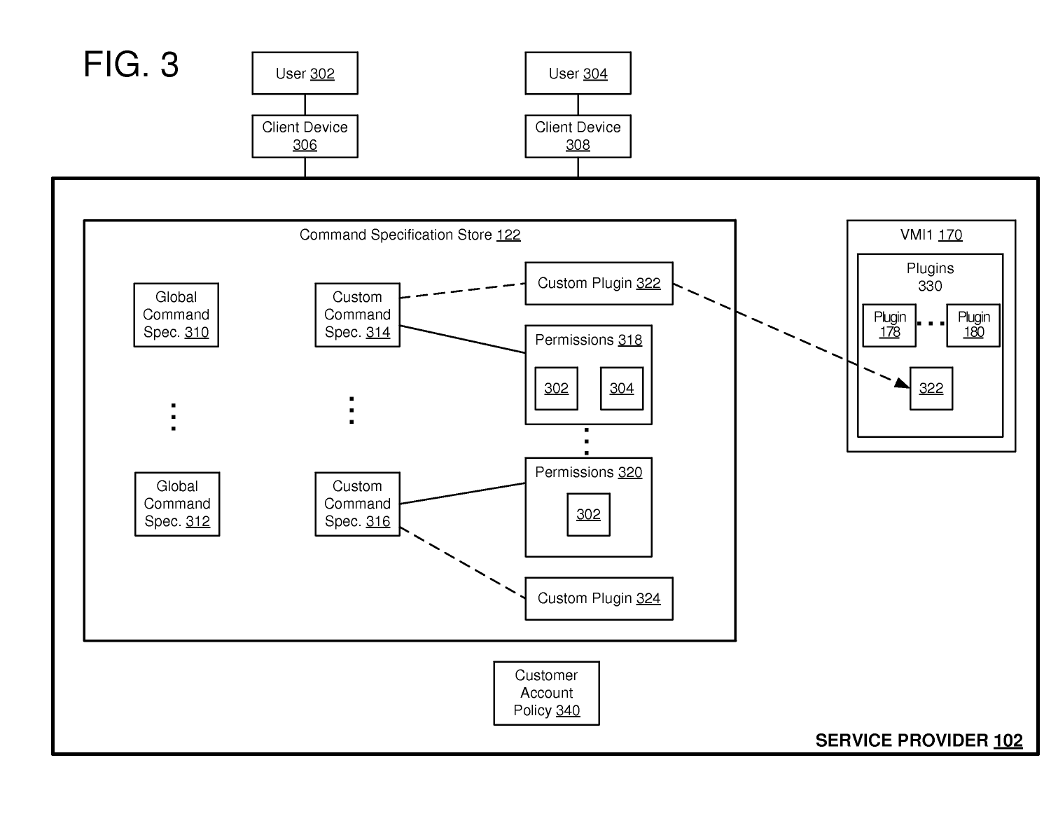

FIG. 3 is a block diagram illustrating command extensibility in a service provider environment using a command execution service, in accordance with an embodiment of the disclosure. Referring to FIGS. 1-3, there is illustrated a more detailed view of the command specification store 122. More specifically, the store 122 may store global command specification documents 310, . . . , 312, as well as custom command specification documents 314, . . . 316.

For example, two separate users 302, 304 may use client devices 306, 308 respectively to access the service provider 102. user 302 may generate a plurality of custom commands and upload the corresponding custom definition/specification documents 314, . . . , 316 to the store 122. The user 302 may also upload the corresponding plug-ins 322, . . . , 324 to the store 122 and/or to one or more of the VMIs 170, . . . , 172. For example, custom plug-in 322 may be uploaded to VMI 170. Furthermore, the uploading user 302 may set permissions 318, . . . , 320 for accessing/using the custom command specifications 314, . . . , 316, respectively. The permissions 318, . . . , 320 may identify one or more users that have a permission to access/use the corresponding plug-in and specification document. In instances when the user 302 decides to give permission to another user (e.g., 304) to use a custom command specification (e.g., 314), then user 304 can also be identified in the permissions 318.

The service provider 122 may also use a policy document (e.g., 340), which may specify one or more policies in connection with command execution services. For example, the customer account policy 340 may specify one or more preferences for presenting the command execution results 132, credentials or authentication information for accessing and using the CES 120, and so forth.

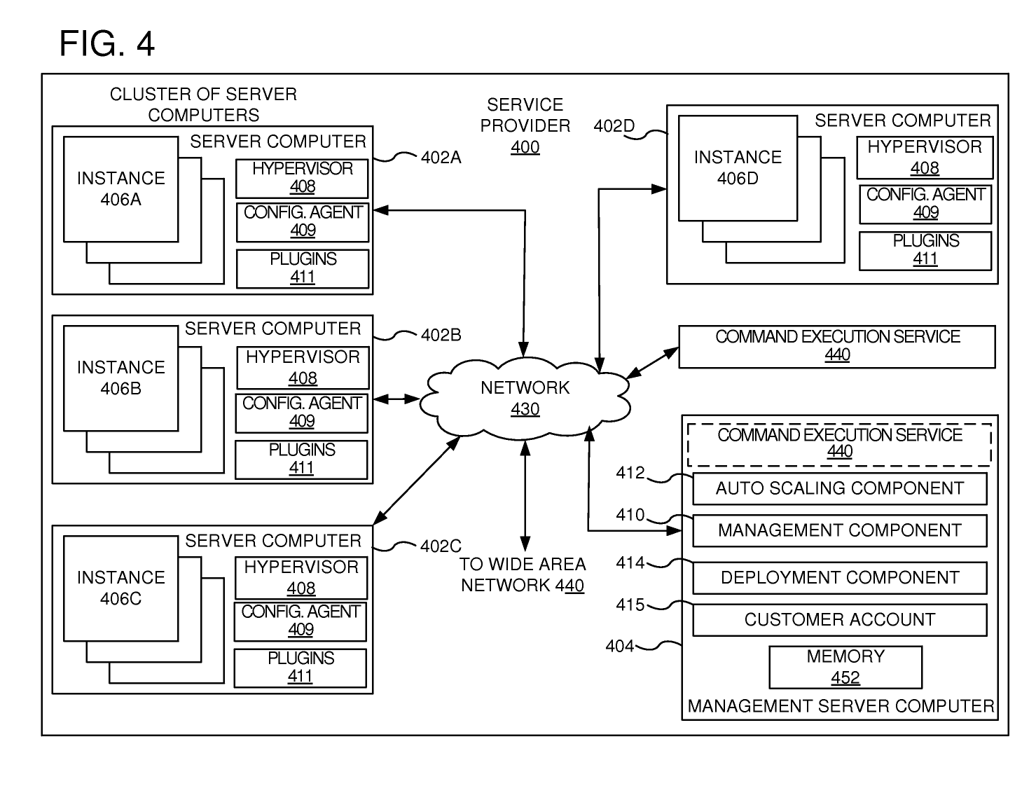

FIG. 4 is an example system diagram showing a plurality of virtual machine instances running in a multi-tenant environment, using a command execution service, in accordance with an example embodiment of the disclosure. More specifically, FIG. 4 is a computing system diagram of a network-based service provider 400 that illustrates one environment in which embodiments described herein can be used. By way of background, the service provider 400 (i.e., the cloud provider) is capable of delivery of computing and storage capacity as a service to a community of end recipients (e.g., tenants or customers). The service provider 400 may be the same as the service provider 102 illustrated in FIGS. 1-3.

In an example embodiment, the service provider 400 can be established for an organization by or on behalf of the organization. That is, the service provider 400 may offer a “private cloud environment.” In another embodiment, the service provider 400 supports a multi-tenant environment, wherein a plurality of customers operate independently (i.e., a public cloud environment). Generally speaking, the service provider 400 can provide the following models: Infrastructure as a Service (“IaaS”), Platform as a Service (“PaaS”), and/or Software as a Service (“SaaS”). Other models can be provided. For the IaaS model, the service provider 400 can offer computers as physical or virtual machines and other resources. The virtual machines can be run as guests by a hypervisor, as described further below. The PaaS model delivers a computing platform that can include an operating system, programming language execution environment, database, and web server. Application developers can develop and run their software solutions on the service provider platform without the cost of buying and managing the underlying hardware and software. The SaaS model allows installation and operation of application software in the service provider. In some embodiments, end users access the service provider 400 using networked customer devices, such as desktop computers, laptops, tablets, smartphones, etc. running web browsers or other lightweight customer applications. Those skilled in the art will recognize that the service provider 400 can be described as a “cloud” environment.

The particular illustrated service provider 400 includes a plurality of server computers 402A-402D. While only four server computers are shown, any number can be used, and large centers can include thousands of server computers. The server computers 402A-402D can provide computing resources for executing software instances 406A-406D. In one embodiment, the instances 406A-406D are virtual machines. As known in the art, a virtual machine is an instance of a software implementation of a machine (i.e., a computer) that executes applications like a physical machine. In the example, each of the server computers 402A-402D can be configured to execute a hypervisor 408 or another type of program configured to enable the execution of multiple instances 406 on a single server. For example, each of the servers 402A-402D can be configured (e.g., via the hypervisor 408) to support one or more virtual machine partitions, with each virtual machine partition capable of running a virtual machine instance (e.g., server computer 402A could be configured to support three virtual machine partitions each running a corresponding virtual machine instance). Additionally, each of the instances 406 can be configured to execute one or more applications, such as a configuration agent 409. The configuration agent 409 may be used to execute one or more commands using the plugins 411. The configuration agent 409 and the plugins 411 are similar to the configuration agents 174, . . . , 176 and plugins 178, . . . , 184 as described in reference to FIG. 1.

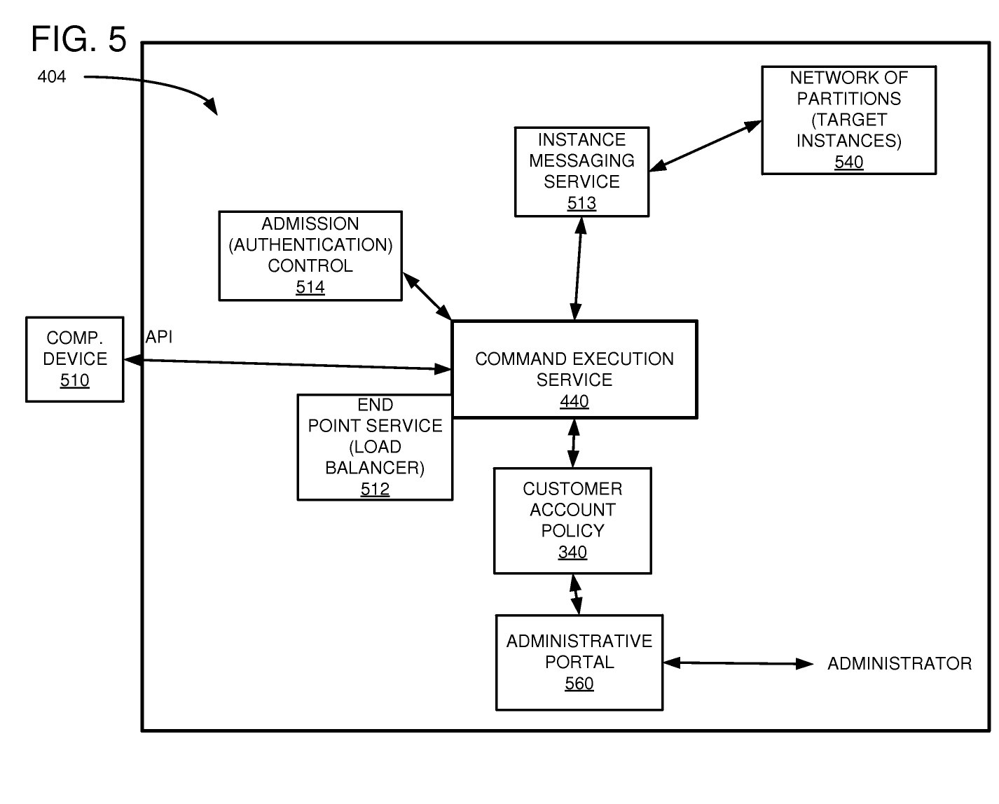

The service provider 400 may also comprise a command execution service 440, which may have the functionalities described herein in connection with the CES 120. The command execution service 440 may be implemented as a stand-alone service within the provider 400, as a dedicated server (similar to the servers 402A-402D), as a code library within one or more of the servers 402, and/or may be implemented as part of the server computer 404 that performs management functions. For example, the protocol selection service 440 may be implemented as part of the management component 410 (as seen in FIG. 5).

It should be appreciated that although the embodiments disclosed herein are described primarily in the context of virtual machines, other types of instances can be utilized with the concepts and technologies disclosed herein. For instance, the technologies disclosed herein can be utilized with storage resources, data communications resources, and with other types of computing resources. The embodiments disclosed herein might also execute all or a portion of an application directly on a computer system without utilizing virtual machine instances.

One or more server computers 404 can be reserved for executing software components for managing the operation of the server computers 402, the instances 406, the hypervisors 408, the configuration agents 409, the plugins 411, and/or the command execution service 440. For example, the server computer 404 can execute a management component 410. A customer can access the management component 410 to configure various aspects of the operation of the instances 406 purchased by the customer. For example, the customer can purchase, rent or lease instances and make changes to the configuration of the instances. The customer can also specify settings regarding how the purchased instances are to be scaled in response to demand.

The server computer 404 may further comprise memory 452, which may be used as processing memory by the command execution service 440. An auto scaling component 412 can scale the instances 406 based upon rules defined by the customer. In one embodiment, the auto scaling component 412 allows a customer to specify scale-up rules for use in determining when new instances should be instantiated and scale-down rules for use in determining when existing instances should be terminated. The auto scaling component 412 can consist of a number of subcomponents executing on different server computers 402 or other computing devices. The auto scaling component 412 can monitor available computing resources over an internal management network and modify resources available based on need.

A deployment component 414 can be used to assist customers in the deployment of new instances 406 of computing resources. The deployment component can have access to account information associated with the instances, such as who is the owner of the account, credit card information, country of the owner, etc. The deployment component 414 can receive a configuration from a customer that includes data describing how new instances 406 should be configured. For example, the configuration can specify one or more applications to be installed in new instances 406, provide scripts and/or other types of code to be executed for configuring new instances 406, provide cache logic specifying how an application cache should be prepared, and other types of information. The deployment component 414 can utilize the customer-provided configuration and cache logic to configure, prime, and launch new instances 406. The configuration, cache logic, and other information may be specified by a customer using the management component 410 or by providing this information directly to the deployment component 414. The instance manager (e.g., 550 in FIG. 5) can be considered part of the deployment component 414.

Customer account information 415 can include any desired information associated with a customer of the multi-tenant environment. For example, the customer account information can include a unique identifier for a customer, a customer address, billing information, licensing information, customization parameters for launching instances, scheduling information, auto-scaling parameters, previous IP addresses used to access the account, and so forth.

A network 430 can be utilized to interconnect the server computers 402A-402D and the server computer 404. The network 430 can include one or more of the Internet, a local area network (LAN) or another type of network, and can be connected to a Wide Area Network (WAN) 440 so that end-users can access the service provider 400. It should be appreciated that the network topology illustrated in FIG. 4 has been simplified and that many more networks and networking devices can be utilized to interconnect the various computing systems disclosed herein.

FIG. 5 shows further details of an example system including a plurality of management components associated with a control plane, which may be used to provide command execution services according to one embodiment. More specifically, FIG. 5 illustrates in further detail components within the management host server 404, which may implement the command execution service 440 within the multi-tenant environment of the service provider 400.

In order to access and utilize instances (such as instances 406 of FIG. 4), a customer device 510 can be used. The customer device 510 can be any of a variety of computing devices, mobile or otherwise, including a cell phone, smartphone, handheld computer, Personal Digital Assistant (PDA), desktop computer, etc. The customer device 510 can communicate with the command execution service 440 in the service provider 400. Optionally, communications with the CES 440 may take place using an end point service (or a load balancer) 512, which can be implemented as part of the CES 440. Using the API requests, a customer device 510 can make requests to implement any of the functionality described herein or to access one or more services provided by the service provider 400. Other general management services that may or may not be included in the service provider 400 (and/or within the management component 410 or the server 404) include an admission/authentication control 514, e.g., one or more computers operating together as an admission/authentication control web service. The admission control 514 can authenticate, validate and unpack the API requests for services provided by the CES 440. The CES 440 may call the authentication control 514 for purposes of providing authentication of clients, client requests, and so forth.

The command execution service 440 may perform the command execution functionalities described herein (e.g., the functionalities described in reference to the CES 120). The CES 440 may communicate with the admission/authentication control 514, with the network of partitions (for target instances) 540 (e.g., to access a virtual desktop instance running on a server computer in order to execute a command), and the policy document 340. Communication with the target instances hosts 540 can be achieved via an instance messaging service 513.

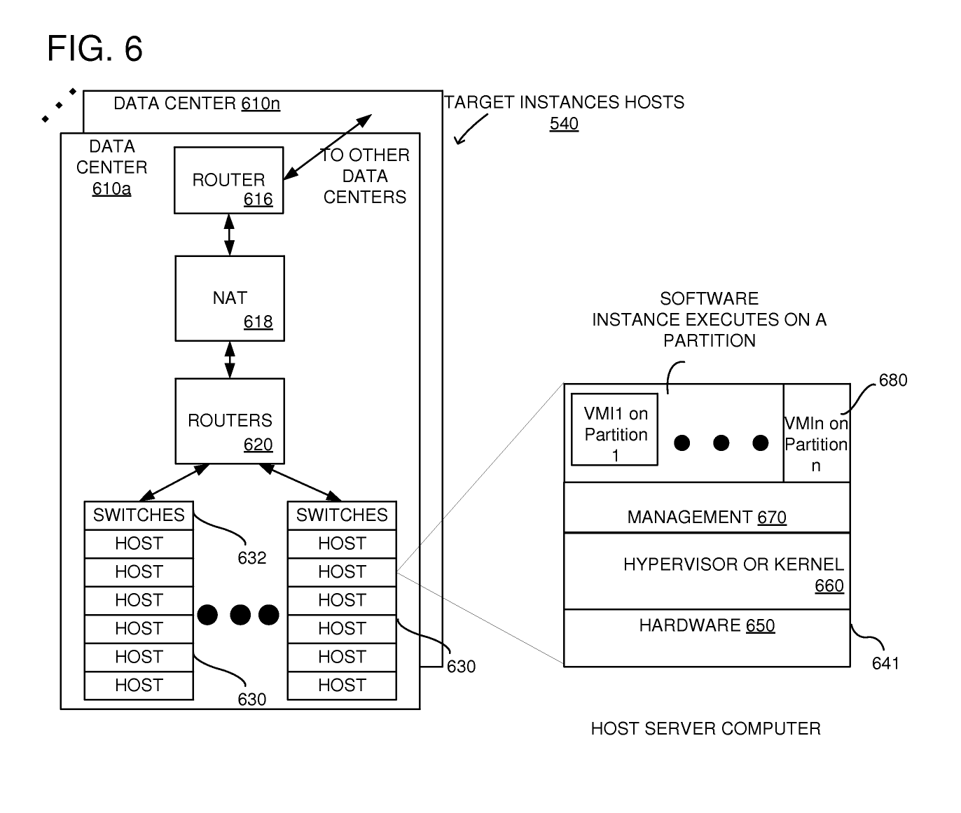

FIG. 6 shows an example of a plurality of host computers, routers, and switches—which are hardware assets used for running virtual machine instances—with the host computers having command execution-related functionalities that may be configured according to one embodiment. More specifically, FIG. 6 illustrates the network of partitions (or target instances hosts) 540 and the physical hardware associated therewith. The network of partitions 540 can include a plurality of data centers, such as data centers 610a, . . . , 610n, coupled together by routers, such as router 616.

The router 616 reads address information in a received packet and determines the packet's destination. If the router decides that a different data center contains a host server computer, then the packet is forwarded to that data center. If the packet is addressed to a host in the data center 610a, then it is passed to a network address translator (NAT) 618 that converts the packet's public IP address to a private IP address. The NAT 618 also translates private addresses to public addresses that are bound outside of the data center 610a. Additional routers 620 can be coupled to the NAT 618 to route packets to one or more racks 630 of host server computers. Each rack 630 can include a switch 632 coupled to multiple host server computers. A particular host server computer is shown in an expanded view at 641.

Each host 641 has underlying hardware 650. Running a layer above the hardware 650 is a hypervisor or kernel layer 660. The hypervisor or kernel layer 660 can be classified as a type 1 or type 2 hypervisor. A type 1 hypervisor runs directly on the host hardware 650 to control the hardware and to manage the guest operating systems. A type 2 hypervisor runs within a conventional operating system environment. Thus, in a type 2 environment, the hypervisor can be a distinct layer running above the operating system and the operating system interacts with the system hardware. Different types of hypervisors include Xen-based, Hyper-V, ESXi/ESX, Linux, etc., but other hypervisors can also be used. In an example embodiment, the hypervisor layer 660 may include the DFS software 409, which may be used to install DSNs or DMNs, as described herein.

A management layer 670 can be part of the hypervisor or separated therefrom, and generally includes device drivers needed for accessing the hardware 650. The partitions 680 are logical units of isolation by the hypervisor. Each partition 680 can be allocated its own portion of the hardware layer's memory, CPU allocation, storage, etc. Additionally, each partition can include a virtual machine and its own guest operating system (e.g., VMI1 may be running on partition 1 and VMIn may be running on partition n). As such, each partition 680 is an abstract portion of capacity designed to support its own virtual machine independent of the other partitions. One or more of the VMIs (VMI1, . . . , VMIn) on partitions 680 may also execute a configuration agent using one or more plugins to execute commands on the VMIs.

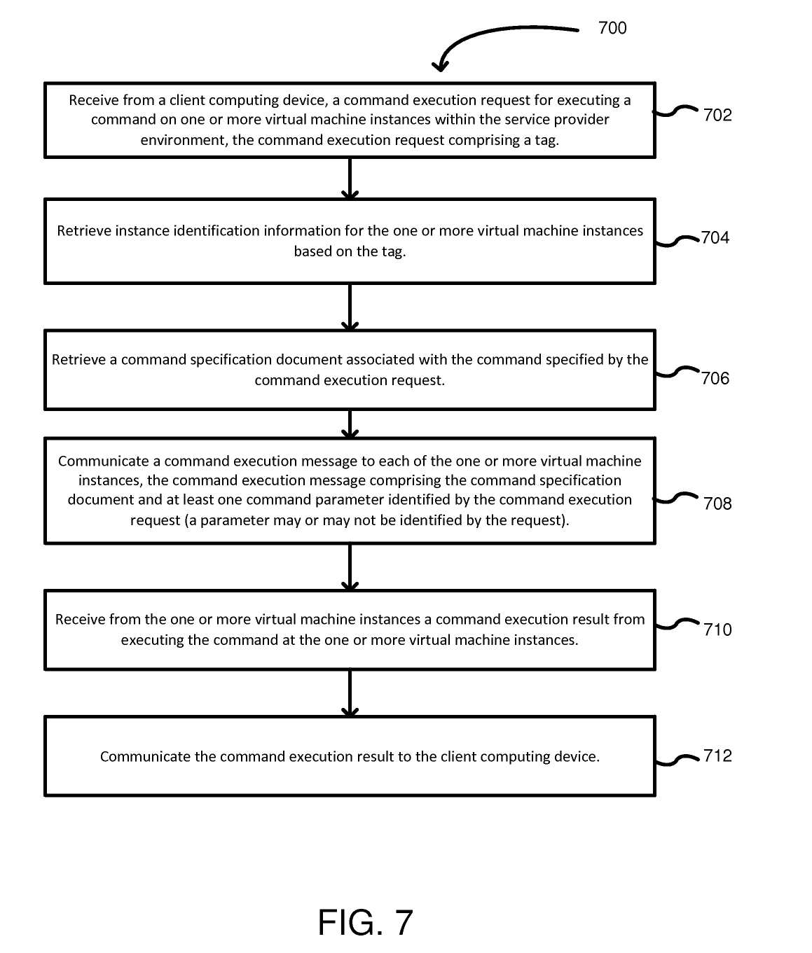

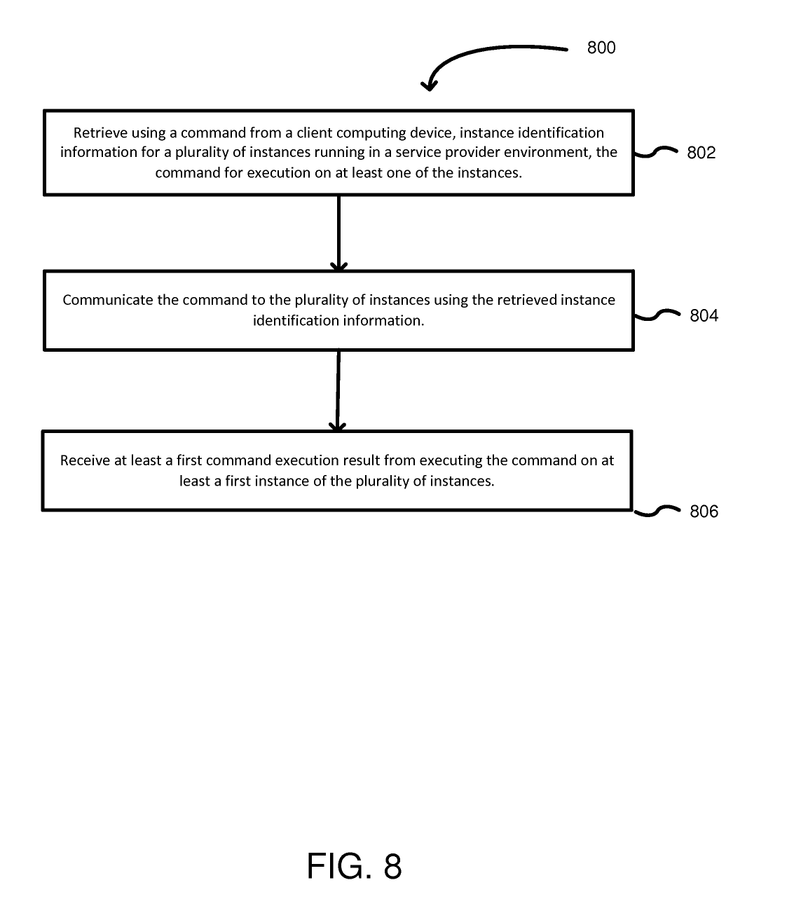

FIGS. 7-8 are flowcharts of example methods of executing commands on virtual machine instances in a service provider environment, in accordance with an embodiment of the disclosure. Referring to FIGS. 1 and 7, the example method 700 may start at 702, when a command execution request for executing a command on one or more virtual machine instances within a service provider environment may be received from a client computing device. For example, the command execution request 110 may be received by the CES 120 from the client device 104. The command execution request may include a tag, such as tag 112. At 704, instance identification information for the one or more virtual machine instances may be retrieved based on the tag. For example, the CES 120 may communicate the tag 112 to the instance identification service 140 and receive instance IDs 142 associated with the tag. In an example embodiment, the instance identification service 140 and/or the instance messaging service 130 may be implemented as part of the CES 120.

At 706, a command specification document associated with the command specified by the command execution request may be retrieved. For example, the CES 120 may use the command 114 identified by the command execution request 110 to retrieve a command specification document (e.g., 126) from the store 122. At 708, a command execution message is communicated to each of the one or more virtual machine instances. For example, the CES 120 can generate the command execution messages 150, . . . , 152 for the identified VMIs associated with instance IDs 142. The command execution messages may include the command specification document (e.g., 126) and at least one command parameter (e.g., 116) identified by the command execution request (e.g., 110). At 710, a command execution result (e.g., 132) from executing the command (e.g., executing the command at VMI 170 using configuration agent 174 and plugin 178) may be receiving from the one or more virtual machine instances (e.g., 170). At 712, the command execution result (e.g., 132) may be communicated to the client computing device (104) via the network 108.

Referring to FIGS. 1 and 8, the example method 800 may start at 802, when instance identification information for a plurality of instances running in a service provider environment may be retrieved using a command from a client computing device, the command for execution on at least one of the instances. For example, the command (e.g., the command execution request 110) may be received by the CES 120 from the client device 104. The command execution request may include a tag, such as tag 112 (or other instance identifying information, such as instance IDs). Instance identification information (e.g., 142) can be obtained (e.g., from service 140) based on the tag 112 within the received command execution request 110.

At 804, the command can be communicated to the plurality of instances using the retrieved instance identification information. For example, the received command (e.g., 114 within request 110) can be used by the CES 120 to retrieve the command specification document (e.g., 126). The CES 120 can then generate the command execution messages 150, . . . , 152 for the identified VMIs associated with instance IDs 142. The command execution messages may include the command specification document (e.g., 126) and at least one command parameter (e.g., 116) identified by the command execution request (e.g., 110). The command execution messages 150, . . . , 152 can be communicated to corresponding VMIs using the messaging service 130, for execution by corresponding configuration agents using a plugin associated with the identified command 114. At 806, at least a first command execution result may be received from executing the command on at least a first instance of the plurality of instances. For example, the configuration agent 174 in VMI 170 may execute the command 114 using the specification document of the command (e.g., 126) and the plugin associated with the command (e.g., 178). A command execution result from executing the command can be generated by the configuration agent 174 and communicated to the CES 120 for further processing (e.g., for communication/display to a user of device 104, offering result editing/storage capabilities to the user, and so forth).

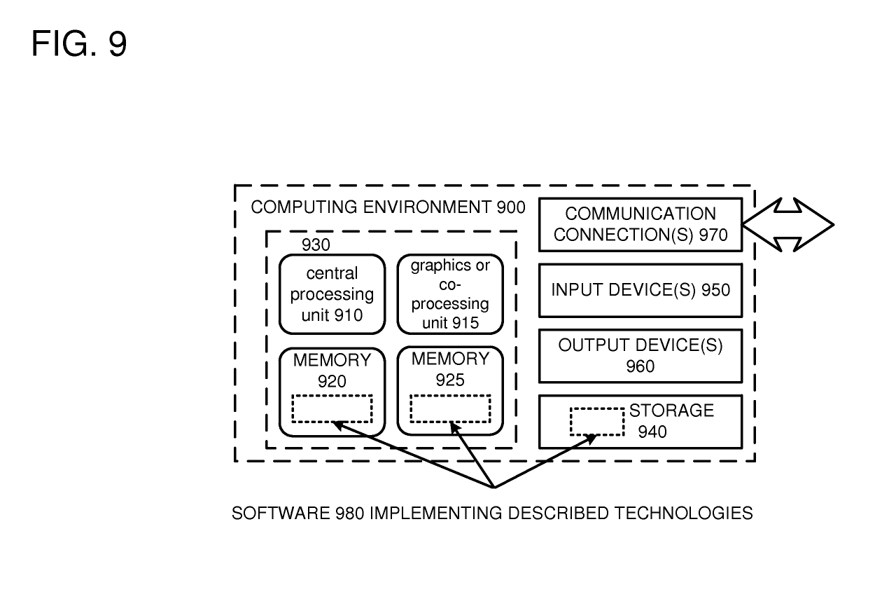

FIG. 9 depicts a generalized example of a suitable computing environment in which the described innovations may be implemented. Referring to FIG. 9, the computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, etc.)

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations (e.g., functionalities) described herein, in the form of computer-executable instructions suitable for execution by the processing unit(s).

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a customer-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. Therefore, what is claimed as the invention is all that comes within the scope of these claims.

What is claimed is:

1. A method for executing commands on virtual machine instances in a distributed computing environment, the method comprising:
receiving, from a client computing device, a command execution request for executing a command on one or more virtual machine instances within the distributed computing environment, the command execution request comprising a tag;
retrieving instance identification information for the one or more virtual machine instances based on the tag;
retrieving a command specification document associated with the command specified by the command execution request;
communicating a command execution message to each of the one or more virtual machine instances, the command execution message comprising the command specification document and at least one command parameter identified by the command execution request;
receiving from the one or more virtual machine instances a command execution result from executing the command at the one or more virtual machine instances; and
communicating the command execution result to the client computing device.

2. The method according to claim 1, wherein the one or more virtual machine instances comprise a plurality of instances, and the method further comprises:
receiving the command execution request via an application programming interface (API).

3. The method according to claim 2, further comprising:
generating the command execution message for each of the plurality of instances; and
communicating the generated messages to the plurality of instances for execution using a plugin associated with the command.

4. The method according to claim 1, wherein the command execution result comprises command execution status or output generated from executing the command.

5. The method according to claim 1, wherein the distributed computing environment comprises an on-premises computing service.

6. The method according to claim 1, wherein the command specification document comprises at least one definition of the command, and the at least one command parameter comprises a key-value pair of parameters used by the at least one definition.

7. A computer-readable storage medium including instructions that, upon execution, cause a computer system to:
retrieve, using a command from a client computing device, instance identification information for a plurality of instances running in a distributed computing environment, the command being for execution on at least one of the instances;
communicate the command to the plurality of instances using the retrieved instance identification information; and
receive at least a first command execution result from executing the command on at least a first instance of the plurality of instances.

8. The computer-readable storage medium according to claim 7, wherein the instructions, upon execution, further cause the computer system to:
receive the command from the client computing device via an application programming interface (API).

9. The computer-readable storage medium according to claim 8, wherein the received command comprises a tag and the instructions, upon execution, further cause the computer system to:
retrieve the instance identification information using the tag.

10. The computer-readable storage medium according to claim 8, wherein the instructions, upon execution, further cause the computer system to:
retrieve a command specification document based on at least a portion of the received command, wherein the command specification document is a custom specification document received from the client computing device.

11. The computer-readable storage medium according to claim 7, wherein at least one of the plurality of instances is running on physical hardware.

12. The computer-readable storage medium according to claim 10, wherein the instructions, upon execution, further cause the computer system to:
update the received command prior to the communicating to include at least a portion of the command specification document.

13. The computer-readable storage medium according to claim 7, wherein the instructions, upon execution, further cause the computer system to:
communicate the at least first command execution result upon receipt to the client computing device.

14. The computer-readable storage medium according to claim 7, wherein the instructions, upon execution, further cause the computer system to:
receive at least a second command execution result from executing the command on at least a second instance of the plurality of instances.

15. The computer-readable storage medium according to claim 14, wherein the instructions, upon execution, further cause the computer system to:
aggregate the at least first and second command execution result to generate an aggregated result.

16. The computer-readable storage medium according to claim 15, wherein the instructions, upon execution, further cause the computer system to:
communicate the aggregated result to the client computing device.

17. A system, comprising:
a plurality of server computers coupled together through a network to form a distributed computing environment, the plurality of server computers for executing a plurality of virtual machine instances; and
a command execution service coupled to the plurality of server computers and a client computing device, the command execution service operable to:
receive from the client computing device, a command execution request for executing a command on at least one of the virtual machine instances within the distributed computing environment, the command execution request comprising instance identification information or one or more tags;
select one or more of the plurality of virtual machine instances based on the instance identification information or the one or more tags;
generate a command execution message for each of the selected one or more virtual machine instances, the command execution message comprising a command specification document with at least one definition of the command; and
communicate the generated command execution message to each of the selected one or more virtual machine instances for execution using a plugin associated with the command.

18. The system of claim 17, wherein the system further comprises an instance messaging service coupled to the command execution service and the plurality of virtual machine instances, and the command execution service is further operable to:
communicate the generated command execution message to each of the one or more virtual machine instances using the instance messaging service.

19. The system of claim 17, wherein the command execution service is further operable to:
receive from the one or more virtual machine instances a command execution result from executing the command; and
communicate the command execution result to the client computing device.

20. The system of claim 17, wherein the command execution service is further operable to:
receive the command specification document or the plugin associated with the command from the client computing device via an API.
